(19) United States
(12) Patent Application Publication
(10) Pub. No.: US 2020/0327108 A1
(43) Pub. Date: Oct. 15, 2020

(54) SYSTEMS AND METHODS FOR INDEXING BIG DATA

(71) Applicant: BEIJING DIDI INFINITY TECHNOLOGY AND DEVELOPMENT CO., LTD., Beijing (CN)

(72) Inventors: Minghao GUO, Beijing (CN); Xiang WEN, Beijing (CN); Yi CHAI, Beijing (CN)

(73) Assignee: BEIJING DIDI INFINITY TECHNOLOGY AND DEVELOPMENT CO., LTD., Beijing (CN)

(21) Appl. No.: 16/914,508

(22) Filed: Jun. 29, 2020

Related U.S. Application Data
(63) Continuation of application No. PCT/CN2017/119699, filed on Dec. 29, 2017.

(51) Int. Cl. G06F 16/22; G06F 16/27

(52) U.S. Cl. CPC G06F 16/2228; G06F 16/278

(57) ABSTRACT

A method for indexing data includes obtaining a plurality of data points each of which includes spatial information. The method also includes dividing the plurality of data points into a plurality of data blocks based on the spatial information, and determining a block serial number for each of the plurality of data blocks. The method also includes dividing the plurality of data blocks into a plurality of partitions based on an estimated distribution and the block serial numbers, and determining a partition serial number for each of the plurality of partitions based on the block serial numbers of the plurality of data blocks. The method also includes determining an index for each of the plurality of data points based on the block serial numbers of the plurality of data blocks and the partition serial numbers of the plurality of partitions.

### CROSS-REFERENCE TO RELATED APPLICATIONS

This application is a continuation of International Application No. PCT/CN2017/119699, filed on Dec. 29, 2017, the contents of which are incorporated herein by reference to its entirety.

### TECHNICAL FIELD

The present disclosure generally relates to management of spatial big data, and more specifically, relates to systems and methods for indexing spatial big data.

### BACKGROUND

In the Internet era, an online on-demand service platform may receive, from its users or other entities, spatial big data including real time or historical locations of the users. The spatial big data may be processed by, for example, Range Query, a k-Nearest Neighbor (KNN) algorithm, or a Spatial Join algorithm. However, because the number of data points in the spatial big data is extremely large and the lack of order for such data, it is difficult to process the spatial big data efficiently. Therefore, it is desirable to provide systems and methods for indexing data to make the data well-organized and easy to process.

### SUMMARY

According to a first aspect of the present disclosure, a system for indexing data may include one or more storage devices and one or more processors configured to communicate with the one or more storage devices. The one or more storage devices may include a set of instructions. When the one or more processors executing the set of instructions, the one or more processors may be directed to perform one or more of the following operations. The one or more processors may obtain a plurality of data points, each of which includes spatial information. The one or more processors may divide the plurality of data points into a plurality of data blocks based on the spatial information of the plurality of data points. The one or more processors may determine a block serial number for each of the plurality of data blocks. The one or more processors may obtain an estimated distribution of the plurality of data points. The one or more processors may divide the plurality of data blocks into a plurality of partitions based on the estimated distribution of the plurality of data points and the block serial numbers of the plurality of data blocks. The one or more processors may determine a partition serial number for each of the plurality of partitions by ranking the plurality of partitions based on the block serial numbers of the plurality of data blocks. The one or more processors may determine an index for each of the plurality of data points based on the block serial numbers of the plurality of data blocks and the partition serial numbers of the plurality of partitions.

In some embodiments, for each of the plurality of partitions, the one or more processors may rank the data blocks included in the partition based on the block serial numbers of the data blocks included in the partition.

In some embodiments, each of the plurality of data points may further include a user identification of a user.

In some embodiments, for each of the plurality of partitions, the one or more processors may re-divide the data points in the partition into a plurality of sub-partitions based on the user identifications of the plurality of data points.

In some embodiments, to re-divide the data points in each of the plurality of partitions into the plurality of sub-partitions based on the plurality of data points, the one or more processors may determine, for each data point in the partition, a Hash value of the user identification corresponding to the data point. The one or more processors may obtain a remainder by dividing the Hash value by an integer. The one or more processors may put the data points corresponding to which the remainders are equal into a same sub-partition. The one or more processors may determine a sub-partition serial number for each of the plurality of sub-partitions based on the remainders corresponding to the data points in the partition.

In some embodiments, to obtain the estimated distribution of the plurality of data points, the one or more processors may select one or more data blocks from the plurality of data blocks. For each of the selected one or more data blocks, the one or more processors may determine a total number of data points included in the each of the selected one or more data blocks. The one or more processors may determine the estimated distribution of the plurality of data points based on the total number of data points in the each of the selected one or more data blocks.

In some embodiments, the one or more processors may determine the block serial number for each of the plurality data blocks based on a space-filling curve.

According to another aspect of the present disclosure, a method for indexing data may include one or more of the following operations. One or more processors may obtain a plurality of data points, each of which includes spatial information. The one or more processors may divide the plurality of data points into a plurality of data blocks based on the spatial information of the plurality of data points. The one or more processors may determine a block serial number for each of the plurality of data blocks. The one or more processors may obtain an estimated distribution of the plurality of data points. The one or more processors may divide the plurality of data blocks into a plurality of partitions based on the estimated distribution of the plurality of data points and the block serial numbers of the plurality of data blocks. The one or more processors may determine a partition serial number for each of the plurality of partitions by ranking the plurality of partitions based on the block serial numbers of the plurality of data blocks. The one or more processors may determine an index for each of the plurality of data points based on the block serial numbers of the plurality of data blocks and the partition serial numbers of the plurality of partitions.

According to yet another aspect of the present disclosure, a non-transitory computer readable medium may comprise at least one set of instructions. The at least one set of instructions may be executed by one or more processors of a computer server. The one or more processors may obtain a plurality of data points, each of which includes spatial information. The one or more processors may divide the plurality of data points into a plurality of data blocks based on the spatial information of the plurality of data points. The one or more processors may determine a block serial number for each of the plurality of data blocks. The one or more processors may obtain an estimated distribution of the plurality of data points. The one or more processors may divide the plurality of data blocks into a plurality of partitions based on the estimated distribution of the plurality of data points and the block serial numbers of the plurality of data blocks. The one or more processors may determine a partition serial number for each of the plurality of partitions by ranking the plurality of partitions based on the block serial numbers of the plurality of data blocks. The one or more processors may determine an index for each of the plurality of data points based on the block serial numbers of the plurality of data blocks and the partition serial numbers of the plurality of partitions.

According to yet another aspect of the present disclosure, a system for indexing data may comprise an obtaining module configured to obtain a plurality of data points, each of which includes spatial information. The system may further comprise a block determination module configured to divide the plurality of data points into a plurality of data blocks based on the spatial information of the plurality of data points and determine a block serial number for each of the plurality of data blocks. The system may further comprise a distribution obtaining module configured to obtain an estimated distribution of the plurality of data points. The system may further comprise a partition determination module configured to divide the plurality of data blocks into a plurality of partitions based on the estimated distribution of the plurality of data points and the block serial numbers of the plurality of data blocks and determine a partition serial number for each of the plurality of partitions by ranking the plurality of partitions based on the block serial numbers of the plurality of data blocks. The system may further comprise an index determination module configured to determine an index for each of the plurality of data points based on the block serial numbers of the plurality of data blocks and the partition serial numbers of the plurality of partitions.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating exemplary hardware and/or software components of a computing device on which a processing engine may be implemented according to some embodiments of the present disclosure;

FIG. 3 is a schematic diagram illustrating exemplary hardware and/or software components of a mobile device on which one or more terminals may be implemented according to some embodiments of the present disclosure;

FIG. 4 is a schematic block diagram illustrating an exemplary processing engine according to some embodiments of the present disclosure;

FIG. 5 is a flowchart illustrating an exemplary process for determining an index for each of a plurality of data points according to some embodiments of the present disclosure;

FIG. 6 is a schematic diagram illustrating an exemplary process for re-dividing a partition into one or more sub-partitions; and

FIG. 7 is a flowchart illustrating an exemplary process for determining an estimated distribution of a plurality of data points according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily regarding determining indexes for a plurality of data points, it should also be understood that this is only one exemplary embodiment. The system and method in the present disclosure may be applied to any application scenario which may produce spatial big data. For example, the system and method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The system and method of the present disclosure may be applied to taxi hailing, chauffeur services, delivery service, carpool, bus service, take-out service, driver hiring, vehicle hiring, bicycle sharing service, train service, subway service, shuttle services, location service, or the like, among others. As used here, big data refers to data of which the amount is large to the extent that requires indexing for efficient processing.

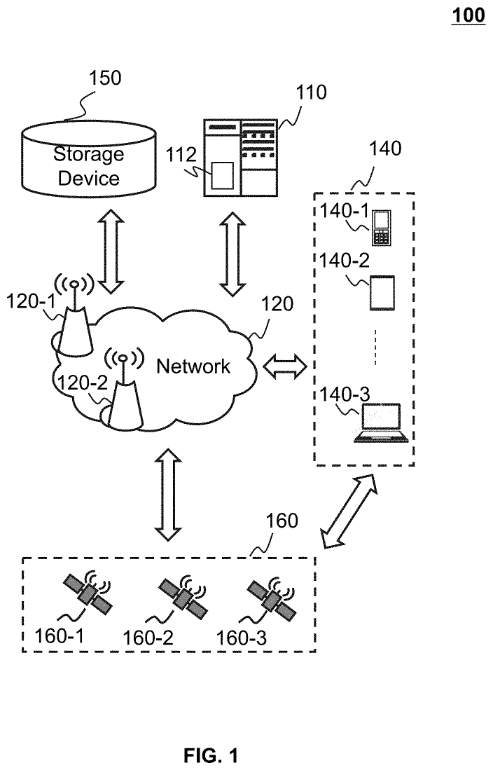

FIG. 1 is a schematic diagram of an exemplary on-demand service system according to some embodiments. The on-demand service system 100 may include a server 110, a network 120, a user terminal 140, a storage device 150, and a positioning system 160.

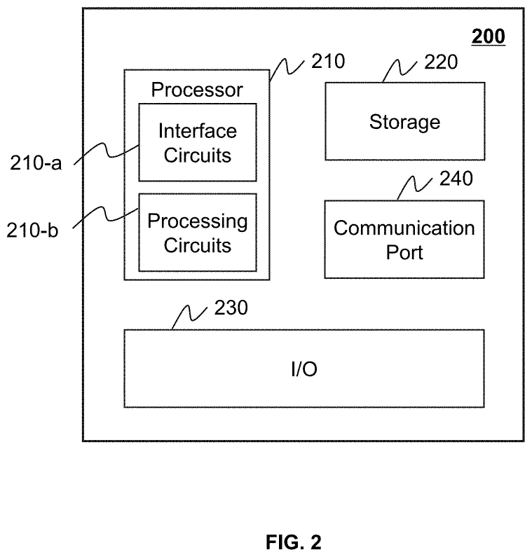

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the user terminal 140, and/or the storage device 150 via the network 120. As another example, the server 110 may be directly connected to the user terminal 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data to perform one or more functions described in the present disclosure. For example, the processing engine 112 may determine an index for a data point. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the on-demand service system 100 (e.g., the server 110, the user terminal 140, the storage device 150, and the positioning system 160) may send information and/or data to other component(s) in the on-demand service system 100 via the network 120. For example, the processing engine 112 may obtain a plurality of data points from the storage device 150 and/or the user terminal 140 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, the user terminal 140 may include a mobile device 140-1, a tablet computer 140-2, a laptop computer 140-3, or the like, or any combination thereof. In some embodiments, the mobile device 140-1 may include a smart home device, a wearable device, a mobile equipment, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile equipment may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, the user terminal 140 may be a device with positioning technology for locating the position of the user terminal 140. In some embodiments, the user terminal 140 may send positioning information to the server 110.

The storage device 150 may store data and/or instructions. In some embodiments, the storage device 150 may store data obtained from the user terminal 140 and/or the processing engine 112. For example, the storage device 150 may store a plurality of data points obtained from the user terminal 140. As another example, the storage device 150 may store indexes of the data points determined by the processing engine 112. In some embodiments, the storage device 150 may store data and/or instructions that the server 110 may execute or use to perform exemplary methods described in the present disclosure. For example, the storage device 150 may store instructions that the processing engine 112 may execute or user to determine indexes for a plurality of data points. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the on-demand service system 100 (e.g., the server 110, the user terminal 140, etc.). One or more components in the on-demand service system 100 may access the data or instructions stored in the storage device 150 via the network 120. In some embodiments, the storage device 150 may be directly connected to or communicate with one or more components in the on-demand service system 100 (e.g., the server 110, the user terminal 140, etc.). In some embodiments, the storage device 150 may be part of the server 110.

The positioning system 160 may determine information associated with an object, for example, the user terminal 140. For example, the positioning system 160 may determine a location of the user terminal 140 in real time. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, an accumulative mileage number, or a current time. The location may be in the form of coordinates, such as, latitude coordinate and longitude coordinate, etc. The positioning system 160 may include one or more satellites, for example, a satellite 160-1, a satellite 160-2, and a satellite 160-3. The satellites 160-1 through 160-3 may determine the information mentioned above independently or jointly. The satellite positioning system 160 may send the information mentioned above to the network 120, or the user terminal 140 via wireless connections.

FIG. 2 is a schematic diagram illustrating exemplary hardware and/or software components of a computing device on which the processing engine 112 may be implemented according to some embodiments of the present disclosure. As illustrated in FIG. 2, the computing device 200 may include a processor 210, a storage 220, an input/output (I/O) 230, and a communication port 240.

The processor 210 (e.g., logic circuits) may execute computer instructions (e.g., program code) and perform functions of the processing engine 112 in accordance with techniques described herein. For example, the processor 210 may include interface circuits 210-a and processing circuits 210-b therein. The interface circuits may be configured to receive electronic signals from a bus (not shown in FIG. 2), wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus.

The computer instructions may include, for example, routines, programs, objects, components, data structures, procedures, modules, and functions, which perform particular functions described herein. For example, the processor 210 may process a plurality of data points obtained from the user terminal 140, the storage device 150, and/or any other component of the on-demand service system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the user terminal 140, the storage device 150, and/or any other component of the on-demand service system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program for the processing engine 112 for determining indexes for data points.

The I/O 230 may input and/or output signals, data, information, etc. In some embodiments, the I/O 230 may enable a user interaction with the processing engine 112. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the processing engine 112 and the user terminal 140, the positioning system 160, or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc.

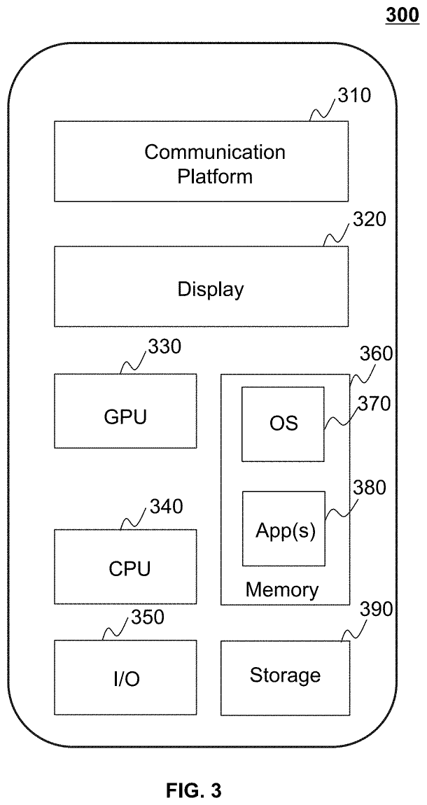

FIG. 3 is a schematic diagram illustrating exemplary hardware and/or software components of a mobile device on which the user terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the on-demand service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

One of ordinary skill in the art would understand that when an element of the on-demand service system 100 performs, the element may perform through electrical signals and/or electromagnetic signals. For example, when the processing engine 112 processes a task, such as making a determination, or identifying information, the processing engine 112 may operate logic circuits in its processor to process such task. When the processing engine 112 receives data (e.g., a plurality of data points) from the user terminal 140, a processor of the processing engine 112 may receive electrical signals including the data. The processor of the processing engine 112 may receive the electrical signals through an input port. If the user terminal 140 communicates with the processing engine 112 via a wired network, the input port may be physically connected to a cable. If the user terminal 140 communicates with the processing engine 112 via a wireless network, the input port of the processing engine 112 may be one or more antennas, which may convert the electrical signals to electromagnetic signals. Within an electronic device, such as the user terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

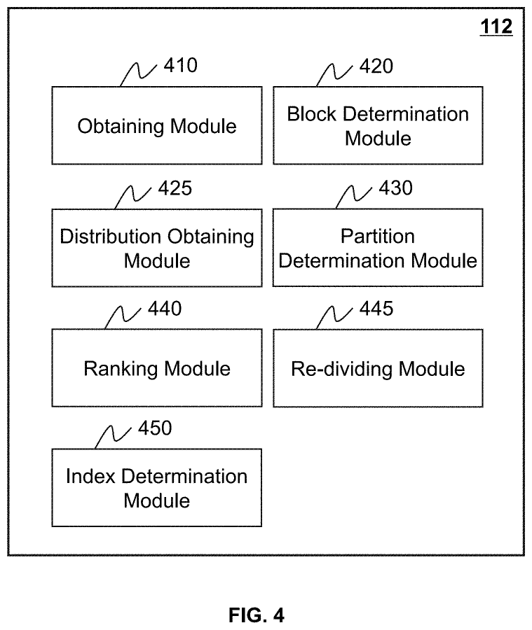

FIG. 4 is a schematic block diagram illustrating an exemplary processing engine according to some embodiments of the present disclosure. The processing engine 112 may include an obtaining module 410, a block determination module 420, a distribution obtaining module 425, a partition determination module 430, a ranking module 440, a re-dividing module 445, and an index determination module 450.

The obtaining module 410 may be configured to obtain a plurality of data points from the storage medium (e.g., the storage device 150, or the storage 220 of the processing engine 112) and/or the user terminal 140. In some embodiments, the number of the plurality of data points may be numerous to the extent that requires indexing for efficient processing. For example, the number of the plurality of data points may be greater than one hundred million. In some embodiments, the number of the plurality of data points may be too numerous to process with existing indexing technology. In some embodiments, a data point may correspond to a user of the on-demand service system 100. In some embodiments, a data point may correspond to one service request made by a user. The term “user” in the present disclosure may refer to an individual, an entity, or a tool that may request a service, order a service, provide a service, or facilitate the providing of the service. In the present disclosure, the terms “user” and “user terminal” may be used interchangeably.

In some embodiments, each of the plurality of data points may include spatial information. The spatial information of a data point may include a time point and a geographic location of a user corresponding to the data point at the time point. In some embodiments, the geographic location may be represented by coordinates of latitude and longitude, an address, or a point of interest (POI) name, or a combination thereof. In some embodiments, the plurality of data points may correspond to a certain time period and/or a certain area. For example, the obtaining module 410 may obtain a plurality of data points that correspond to one day in Beijing.

In some embodiments, the user terminal 140 may establish a communication (e.g., a wireless communication) with the processing engine 112 and/or the storage device 150, via an application installed in the user terminal 140. The application may be associated with the on-demand service system 100. For example, the application may be a taxi-hailing application or a navigation application. The provider terminal 140 may obtain a location of a user through a positioning technology in the user terminal 140, for example, a GPS, a GLONASS, a COMPASS, a QZSS, a WiFi positioning technology, or the like, or any combination thereof. The application may direct the user terminal 140 to constantly send the real time or historical location of the user to the processing engine 112 and/or the storage device 150. Consequently, the processing engine 112 and/or the storage device 150 may receive the location of the user in real time or substantially real time. In addition, the processing engine 112 and/or the storage device 150 may also receive historical location of the user corresponding to specific time point or time period.

In some embodiments, each of the plurality of data points may further include a user identification (ID) of a user corresponding to the data point. The user may register an account of the application when the user first uses the application and the processing engine 112 may generate a user ID for the user after the registration. The application may direct the user terminal 140 to send the user ID to the processing engine 112 and/or the storage device 150 along with the real time or historical location of the user.

In some embodiments, at least one of the plurality of data points may include information associated with a user corresponding to the at least one of the plurality of data points. The information associated with the user may include the name of the user, the age of the user, the phone number of the user, the gender of the user, the occupation of the user, a vehicle relating to the user, the plate number of the vehicle, the brand of the vehicle, the color of the vehicle, or the like, or any combination thereof. In some embodiments, such user information is included in all the data points or a portion of the data points. The user may input the information associated with the user through an interface of the application. The application may direct the user terminal 140 to send the information associated with the user to the processing engine 112 and/or the storage device 150 along with the real time or historical location of the user.

In some embodiments, when a user is in a process of requesting, using, or providing an on-demand service (e.g., a driver is providing a taxi-hailing service to a passenger), the application may direct the user terminal 140 associated with the user to send information associated with the on-demand service to the processing engine 112 and/or the storage device 150 along with the real time or historical location of the user. For example, when a user (e.g., a driver) is providing a taxi-hailing service to a passenger, the information associated with the taxi-hailing service being provided may include an origin of the trip, a destination of the trip, or the like, or any combination thereof.

The block determination module 420 may be configured to divide the plurality of data points into a plurality of data blocks. In some embodiments, the block determination module 420 may divide the plurality of data points into a plurality of data blocks based on the spatial information of the plurality of data points. Alternatively or additionally, the block determination module 420 may first divide certain area that the plurality of data points correspond to into a plurality of sub-areas, each corresponding to a data block, and then determine how many data points and/or which data points are in each data block based on the spatial information of the plurality of data points.

In some embodiments, a data block may represent a geographic region (sub-area). In some embodiments, each of the geographic region may have a regular (e.g. triangle, rectangle, square, circle, pentagon, hexagon, etc.) or irregular shape. In some embodiments, the sizes of the geographic regions may be the same. For example, each of the geographic region may be a square of which the side length is 500 meters. In some embodiments, the sizes of the geographic regions may be different. For example, geographic region A may be a square of which the side length is 200 meters, and geographic region B is a square of which the side length is 300 meters.

The block determination module 420 may be further configured to determine a block serial number for each of the plurality of data blocks. In some embodiments, the block determination module 420 may determine the block serial numbers based on a space-filling curve, for example, a Hilbert curve, a Z-order curve, a Quad tree, R-trees, a Hilbert R-tree, a Binary Space Partitioning (BSP) tree, a Gray curve, a Dragon curve, a Gosper curve, a Peano curve, or the like, or any combination thereof. In some embodiments, the space-filling curve is a Hilbert curve that, when used a map, passes through the geographic regions corresponding to the data blocks, leaving no empty space and no overlap. The block determination module 420 may number the plurality of data blocks according to the order that the space-filling curve passes through the geographic regions corresponding to the plurality of data blocks.

The distribution obtaining module 425 may be configured to obtain an estimated distribution of the plurality of data points. The estimated distribution of the plurality of data points may indicate which data blocks include relatively more data points and which data blocks include relatively fewer data points. The estimated distribution may include an estimated density distribution of the plurality of data points, an estimated number distribution of the plurality of data points, or the like, or any combination thereof.

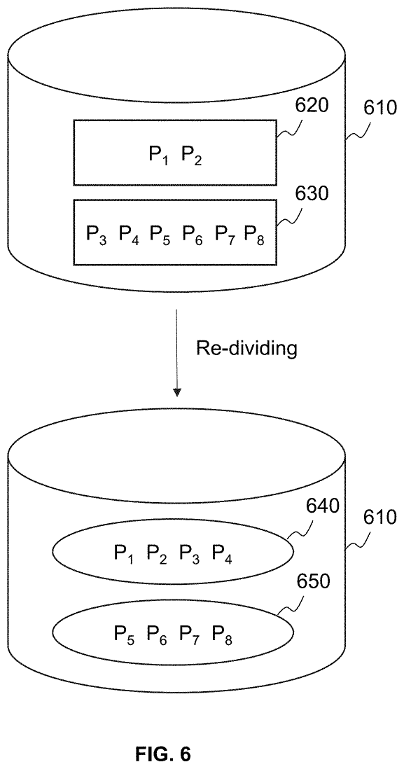

For example, for the estimated density distribution, the distribution obtaining module 425 may determine, for each data block, a density of data points in the data block based on the number of data points in the data block and the size of geographic region corresponding to the data block. The distribution obtaining module 425 may determine the estimated density distribution based on the density of data points in each data block. Alternatively, the distribution obtaining module 425 may select one or more data blocks from the plurality of data blocks as a sample, and determine the estimated density distribution based on the density of data points in each of the selected one or more data blocks (e.g., as described elsewhere in this disclosure in detail in connection with FIG. 6).

As another example, for the estimated number distribution, the distribution obtaining module 425 may determine the number of data points in each data block, and determine the estimated number distribution based on the number of data points in each data block. Alternatively, the distribution obtaining module 425 may select one or more data blocks from the plurality of data blocks as a sample, and determine the estimated number distribution based on the number of data points in each of the selected one or more data blocks (e.g., as described elsewhere in this disclosure in detail in connection with FIG. 6).

The partition determination module 430 may be configured to divide the plurality of data blocks into a plurality of partitions based on the estimated distribution of the plurality of data points and the block serial numbers of the plurality of data blocks. In order to improve the efficiency of data point processing, the number of data points in each partition may be substantially similar (e.g., differences between the numbers of data points in any two partitions are less than a first number threshold such as 100, 500, 1000, 5000, or 10000 data points; or the differences are less than a first percentage threshold such as but not limited to 10%, 15%, 20%, 25%, or 30%). In some embodiments, the partition determination module 430 may divide the plurality of data blocks into the plurality of partitions based on the estimated distribution of the plurality of data points to make the number of data points in each partition substantially similar. In some embodiments, the block serial numbers of data blocks in a partition may be continuous. For example, the block serial numbers of data blocks in a partition may be 1-10000.

The partition determination module 430 may be further configured to determine a partition serial number for each of the plurality of partitions by ranking the plurality of partitions based on the block serial numbers of the plurality of data blocks. For example, the partition determination module 430 may determine a partition serial number of BU₁ for a partition that includes data blocks of which the block serial numbers are 1-10000, and determine a partition serial number of BU₂ for a partition includes data blocks of which the block serial numbers are 10001-11000.

The ranking module 440 may be configured to rank, for each of the plurality of partitions, the data blocks included in the partition based on the block serial numbers of the data blocks included in the partition. For example, a partition includes 1000 data blocks of which the block serial numbers are 10001-11000. In some embodiments, the ranking module 440 may rank the 1000 data blocks in the ascending order and determine the data block with the block serial number of 10001 as the first data block in the partition. Alternatively, in some embodiments, the ranking module 440 may rank the 1000 data blocks in the descending order and determine the data block with the block serial number of 11000 as the first data block in the partition.

The re-dividing module 445 may be configured to re-divide the data points in each or some of the partitions into a plurality of sub-partitions. In some embodiments, the re-dividing module 445 is configured to re-divide the data points in each partition into a plurality of sub-partitions. The number of data points in each sub-partition may be substantially similar (e.g., differences between the numbers of data points in any two sub-partitions are less than a second number threshold such as 50, 100, 500, 1000 or 5000 data points or less than a second percentage threshold such as but not limited to 5%, 10%, 15%, or 20%).

The index determination module 450 may be configured to determine an index (also referred to as a spatial index) for each of the plurality of data points based on the block serial numbers of the plurality of data blocks and/or the partition serial numbers of the plurality of partitions. In some embodiments, the index for the data points is based on the block serial numbers of the data blocks and the partition serial numbers of the partitions. In some embodiments, the index of a data point may indicate the data block and the partition that the data point belongs to.

In some embodiments, when the partition determination module 430 re-divide each of the plurality of partitions into a plurality of sub-partitions, the index determination module 450 may determine an index for each of the plurality of data points based on the partition serial numbers of the plurality of partitions and the sub-partition serial numbers of the plurality of sub-partitions. In the case, the index of a data point may indicate the sub-partition and the partition that the data point belongs to.

The modules in the processing engine 112 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. It is not required that all the modules are present in all the embodiments. For example, in some embodiments, the re-dividing module 445 may not be present. Two or more of the modules may be combined into a single module, and any one of the modules may be divided into two or more units. For example, the partition determination module 430 and the ranking module 440 may be combined into a single module which may both divide the plurality of data blocks into the plurality of partitions and rank the one or more data blocks included in each of the plurality of partitions. As another example, the block determination module 420 may be divided into two units. One unit may be configured to determine a plurality of data blocks. The other unit may be configured to determine a block serial number for each of the plurality of data blocks.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the processing engine 112 may further include a storage module (not shown in FIG. 4). The storage module may be configured to store data generated during any process performed by any component of in the processing engine 112. As another example, each of components of the processing engine 112 may correspond to a storage module, respectively. Additionally or alternatively, the components of the processing engine 112 may share a common storage module. As still another example, the ranking module 440 and/or the re-dividing module 445 may be omitted.

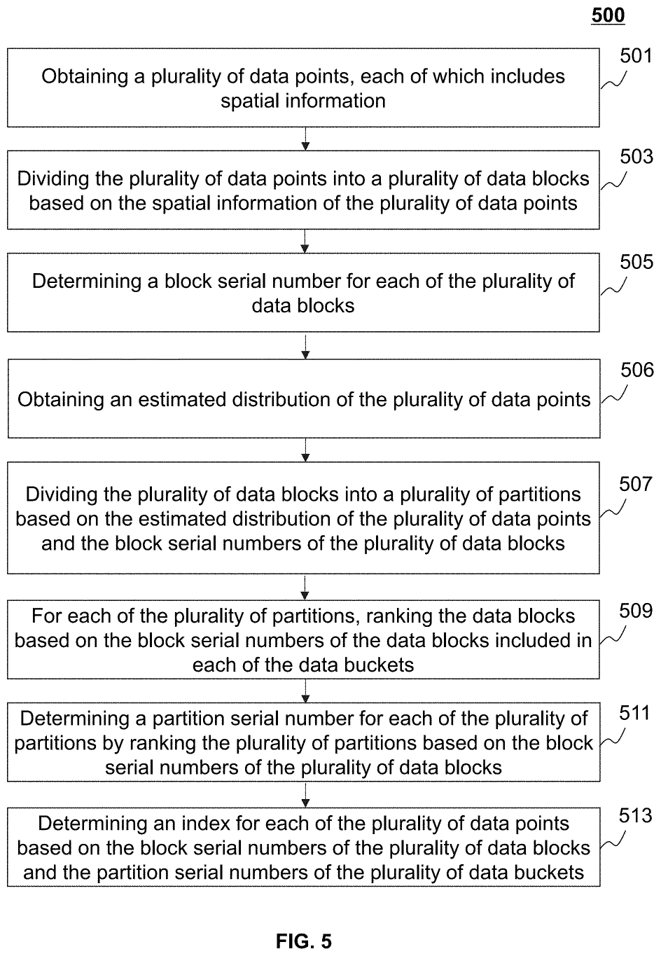

FIG. 5 is a flowchart illustrating an exemplary process for determining an index for each of a plurality of data points according to some embodiments of the present disclosure. In some embodiments, the process 500 may be implemented in the on-demand service system 100 illustrated in FIG. 1. For example, the process 500 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In 501, the obtaining module 410 (or the processing engine 112, and/or the interface circuits 210-a) may obtain a plurality of data points from the storage medium (e.g., the storage device 150, or the storage 220 of the processing engine 112) and/or the user terminal 140. In some embodiments, the number of the plurality of data points may be numerous to the extent that requires indexing for efficient processing. For example, the number of the plurality of data points may be greater than one hundred million. In some embodiments, the number of the plurality of data points may be too numerous to process with existing indexing technology. In some embodiments, a data point may correspond to a user of the on-demand service system 100.

In some embodiments, each of the plurality of data points may include spatial information. The spatial information of a data point may include a time point and a geographic location of a user corresponding to the data point at the time point. In some embodiments, the geographic location may be represented by coordinates of latitude and longitude, an address, or a point of interest (POI) name, or a combination thereof. In some embodiments, the plurality of data points may correspond to a certain time period and/or a certain area. For example, the obtaining module 410 may obtain a plurality of data points that corresponding to one day in Beijing.

In some embodiments, the user terminal 140 may establish a communication (e.g., a wireless communication) with the processing engine 112 and/or the storage device 150, via an application installed in the user terminal 140. The application may be associated with the on-demand service system 100. For example, the application may be a taxi-hailing application or a navigation application. The provider terminal 140 may obtain a location of a user through a positioning technology in the user terminal 140, for example, a GPS, a GLONASS, a COMPASS, a QZSS, a WiFi positioning technology, or the like, or any combination thereof. The application may direct the user terminal 140 to constantly send the real time or historical location of the user to the processing engine 112 and/or the storage device 150. Consequently, the processing engine 112 and/or the storage device 150 may receive the location of the user in real time or substantially real time. In addition, the processing engine 112 and/or the storage device 150 may also receive historical location of the user corresponding to specific time point or time period.

In some embodiments, each of the plurality of data points may further include a user identification (ID) of a user corresponding to the data point. The user may register an account of the application when the user first uses the application. The processing engine 112 may generate a user ID for the user after the user registration. The application may direct the user terminal 140 to send the user ID to the processing engine 112 and/or the storage device 150 along with the real time or historical location of the user.

In some embodiments, at least one of the plurality of data points may include information associated with a user corresponding to the at least one of the plurality of data points. The information associated with the user may include the name of the user, the age of the user, the phone number of the user, the gender of the user, the occupation of the user, a vehicle relating to the user, the plate number of the vehicle, the brand of the vehicle, the color of the vehicle, or the like, or any combination thereof. In some embodiments, such user information is included in all the data points or a portion of the data points. The user may input the information associated with the user through an interface of the application. The application may direct the user terminal 140 to send the information associated with the user to the processing engine 112 and/or the storage device 150 along with the real time or historical location of the user.

In some embodiments, when a user is in a process of requesting, using, or providing an on-demand service (e.g., a driver is providing a taxi-hailing service to a passenger), the application may direct the user terminal 140 associated with the user to send information associated with the on-demand service to the processing engine 112 and/or the storage device 150 along with the real time or historical location of the user. For example, when a user (e.g., a driver) is providing a taxi-hailing service to a passenger, the information associated with the taxi-hailing service being provided may include an origin of the trip, a destination of the trip, or the like, or any combination thereof.

In 503, the block determination module 420 (or the processing engine 112, and/or the processing circuits 210-b) may divide the plurality of data points into a plurality of data blocks. In some embodiments, the block determination module 420 may directly divide the plurality of data points into a plurality of data blocks based on the spatial information of the plurality of data points. Alternatively or additionally, the block determination module 420 may first divide the certain area that the plurality of data points correspond to into a plurality of data blocks, and then determine how many data points and/or which data points are in each data block based on the spatial information of the plurality of data points.

In some embodiments, a data block may represent a geographic region (sub-area). In some embodiments, each of the geographic region may have a regular (e.g. triangle, rectangle, square, circle, pentagon, hexagon, etc.) or irregular shape. In some embodiments, the sizes of geographic regions may be same. For example, each of the geographic region may be a square of which the side length is 500 meters. In some embodiments, the sizes of geographic regions may be different. For example, the geographic region A may be a square of which the side length is 200 meters, and the geographic region B is a square of which the side length is 300 meters.

In 505, the block determination module 420 (or the processing engine 112, and/or the processing circuits 210-b) may determine a block serial number for each of the plurality of data blocks. In some embodiments, the block determination module 420 may determine the block serial numbers based on a space-filling curve, for example, a Hilbert curve, a Z-order curve, a Quad tree, R-trees, a Hilbert R-tree, a Binary Space Partitioning (BSP) tree, a Gray curve, a Dragon curve, a Gosper curve, a Peano curve, or the like, or any combination thereof. In some embodiments, the space-filling curve is a Hilbert curve that, when used a map, passes through the geographic regions corresponding to the data blocks, leaving no empty space and no overlap. The block determination module 420 may number the plurality of data blocks according to the order that the space-filling curve passes through geographic regions corresponding to the plurality of data blocks.

In 506, the distribution obtaining module 425 may obtain an estimated distribution of the plurality of data points. The estimated distribution of the plurality of data points may indicate which data blocks include relatively more data points and which data blocks include relatively fewer data points. The estimated distribution may include an estimated density distribution of the plurality of data points, an estimated number distribution of the plurality of data points, or the like, or any combination thereof.

For example, for the estimated density distribution, the distribution obtaining module 425 may determine, for each data block, a density of data points based on the number of data points in the data block and the size of the geographic region corresponding to the data block, and determine the estimated density distribution based on the density of data points in each data block. Alternatively, the distribution obtaining module 425 may select one or more data blocks from the plurality of data blocks as a sample, and determine the estimated density distribution based on the density of data points in each of the selected one or more data blocks (e.g., as described elsewhere in this disclosure in detail in connection with FIG. 6).

As another example, for the estimated number distribution, the distribution obtaining module 425 may determine the number of data points in each data block, and determine the estimated number distribution based on the number of data points in each data block. Alternatively, the distribution obtaining module 425 may select one or more data blocks from the plurality of data blocks as a sample, and determine the estimated number distribution based on the number of data points in each of the selected one or more data blocks (e.g., as described elsewhere in this disclosure in detail in connection with FIG. 6).

In 507, the partition determination module 430 (or the processing engine 112, and/or the processing circuits 210-b) may divide the plurality of data blocks into a plurality of partitions based on the estimated distribution of the plurality of data points and the block serial numbers of the plurality of data blocks. In order to improve the efficiency of data point processing, the number of data points in each partition may be substantially similar (e.g., differences between the numbers of data points in any two partitions are less than a first number threshold such as 100, 500, 1000, 5000, or 10000 data points; or the differences are less than a first percentage threshold such as but not limited to 10%, 15%, 20%, 25%, or 30%). In some embodiments, the partition determination module 430 may divide the plurality of data blocks into the plurality of partitions based on estimated distribution of the plurality of data points to make the number of data points in each partition substantially similar. In some embodiments, the block serial numbers of data blocks in a partition may be continuous. For example, the block serial numbers of data blocks in a partition may be 1-10000.

In 509, for each of the plurality of partitions, the ranking module 440 (or the processing engine 112, and/or the processing circuits 210-b) may rank the data blocks included in the partition based on the block serial numbers of the data blocks included in the partition. For example, a partition includes 1000 data blocks of which the block serial numbers are 10001-11000. In some embodiments, the ranking module 440 may rank the 1000 data blocks in the ascending order and determine the data block with the block serial number of 10001 as the first data block in the partition. Alternatively, in some embodiments, the ranking module 440 may rank the 1000 data blocks in the descending order and determine the data block with the block serial number of 11000 as the first data block in the partition.

In 511, the partition determination module 430 (or the processing engine 112, and/or the processing circuits 210-b) may determine a partition serial number for each of the plurality of partitions by ranking the plurality of partitions based on the block serial numbers of the plurality of data blocks. For example, the partition determination module 430 may determine a partition serial number of BU₁ for a partition that includes data blocks of which the block serial numbers are 1-10000, and determine a partition serial number of BU₂ for a partition includes data blocks of which the block serial numbers are 10001-11000.

In some embodiments, a data set including data points that are divided into a plurality of partitions may be processed in partitions. However, the amount of data in a partition may be so large that the processing efficiency is low. In order to improve the processing efficiency, after the partition determination module 430 determines the partition serial numbers, the re-dividing module 445 may re-divide the data points in each or some of the partitions into a plurality of sub-partitions, so that the data points may be processed in sub-partitions. In some embodiments, the re-dividing module 445 is configured to re-divide the data points in each partition into a plurality of sub-partitions. The number of data points in each sub-partition may be substantially similar (e.g., differences between the numbers of data points in any two sub-partitions are less than a second number threshold such as 100, 500, 1000, 5000, or 10000 data points; or the differences are less than a first percentage threshold such as but not limited to 10%, 15%, 20%, 25%, or 30%).

As shown in FIG. 6, a partition 610 may include a data block 620 and a data block 630. The data block 620 may include a data point P₁ and a data point P₂. The data block 630 may include data points P₃-P₈. The re-dividing module 445 may re-divide the partition 610 into a sub-partition 640 and a sub-partition 650 to make the numbers of data points in the sub-partition 640 and the sub-partition 650 substantially similar.

Merely by way of example, the re-dividing module 445 may determine the plurality of sub-partitions by combining at least two of the data blocks in the partition, dividing at least one of the data blocks in the partition into a plurality of sub-blocks, combining at least two of the plurality of sub-blocks, or the like, or any combination thereof. In some embodiments, the re-dividing module 445 may divide a plurality of data blocks in the partition into a plurality of sub-blocks, and combine the sub-blocks into one or more sub-partitions.

Merely by way of example, the re-dividing module 445 may determine a sub-partition serial number for each sub-partition based on user IDs of the plurality of data points. For a data point, the re-dividing module 445 may determine a Hash value of the user ID of the data point. In certain embodiments, the re-dividing module 445 may divide the Hash value by 10 and obtain a remainder of the division. The re-dividing module 445 may put the data points corresponding to which the remainders are equal into a same sub-partition, and determine the remainder as the sub-partition serial number of the sub-partition.

In 513, the index determination module 450 (or the processing engine 112, and/or the processing circuits 210-b) may determine an index for each of the plurality of data points based on the block serial numbers of the plurality of data blocks and/or the partition serial numbers of the plurality of partitions. The index of a data point may indicate the data block and the partition that the data point is included in.

In some embodiments, when the re-dividing module 445 re-divides each partition into a plurality of sub-partitions, the index determination module 450 may determine an index for each of the plurality of data points based on the partition serial numbers of the plurality of partitions, the block serial numbers of the plurality of data blocks, and the sub-partition serial numbers of the plurality of sub-partitions. The index of a data point may indicate the sub-partition and the partition that the data point is included in.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, step 509 may be omitted in some embodiments.

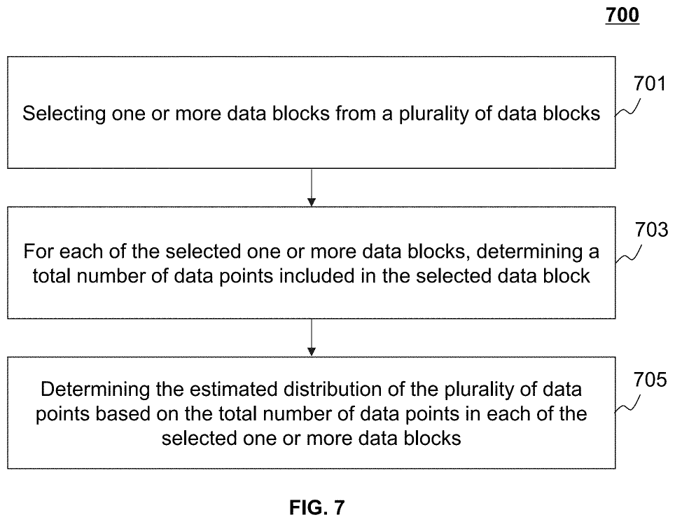

FIG. 7 is a flowchart illustrating an exemplary process for determining an estimated distribution of a plurality of data points according to some embodiments of the present disclosure. In some embodiments, the process 700 may be implemented in the on-demand service system 100 illustrated in FIG. 1. For example, the process 700 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 700 presented below are intended to be illustrative. In some embodiments, the process 700 may be accomplished with one or more additional operations not described, and/or without one or more of the operations discussed. Additionally, the order in which the operations of the process 700 as illustrated in FIG. 7 and described below is not intended to be limiting. In some embodiments, step 506 illustrated in FIG. 5 may be performed according to the process 700.

In 701, the distribution obtaining module 425 (or the processing engine 112, and/or the processing circuits 210-b) may select one or more data blocks from the plurality of data blocks. In some embodiments, the distribution obtaining module 425 may select the one or more data blocks randomly.

In 703, for each of the selected one or more data blocks, the distribution obtaining module 425 (or the processing engine 112, and/or the processing circuits 210-b) may determine the total number of data points included in the selected data block.

In 705, the distribution obtaining module 425 (or the processing engine 112, and/or the processing circuits 210-b) may determine the estimated distribution of the plurality of data points based on the total number of data points in each of the selected one or more data blocks. In some embodiments, the estimated distribution of the plurality of data points may indicate which data blocks include relatively more data points and which data blocks include relatively fewer data points. For example, the estimated distribution may indicate that data blocks with serial numbers 10001 to 11000 may have an estimated average data point number of 100/block, and data blocks with serial numbers 11001 to 12000 may have an estimated average data point number of 150/block. In some embodiments, the estimated distribution may include an estimated density distribution of the plurality of data points, an estimated number distribution of the plurality of data points, or the like, or any combination thereof.

In some embodiments, for each of the selected one or more data blocks, the distribution obtaining module 425 may determine a density of data points in the selected data block based on the total number of data points in the selected data block and the number of the data blocks. The distribution obtaining module 425 may determine the estimated density distribution of the data points included in the selected one or more data blocks based on the density of data points in each of the selected one or more data blocks.

Alternatively, the distribution obtaining module 425 may determine the estimated number distribution of the data points included in the selected one or more data blocks based on the total number of data points in each of the selected one or more data blocks.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for indexing data, comprising:
one or more storage media comprising a set of instructions; and
one or more processors configured to communicate with the one or more storage media, wherein when executing the set of instructions, the one or more processors are directed to cause the system to:
obtain a plurality of data points, each of which includes spatial information;
divide the plurality of data points into a plurality of data blocks based on the spatial information of the plurality of data points;
determine a block serial number for each of the plurality of data blocks;
obtain an estimated distribution of the plurality of data points;
divide the plurality of data blocks into a plurality of partitions based on the estimated distribution of the plurality of data points and the block serial numbers of the plurality of data blocks;
determine a partition serial number for each of the plurality of partitions by ranking the plurality of partitions based on the block serial numbers of the plurality of data blocks; and
determine an index for each of the plurality of data points based on the block serial numbers of the plurality of data blocks and the partition serial numbers of the plurality of partitions.

2. The system of claim 1, wherein when executing the set of instructions, the one or more processors are further directed to cause the system to:
for each of the plurality of partitions, rank the data blocks included in the partition based on the block serial numbers of the data blocks included in the partition.

3. The system of claim 1, wherein each of the plurality of data points further includes a user identification of a user.

4. The system of claim 3, wherein when executing the set of instructions, the one or more processors are further directed to cause the system to:
for each of the plurality of partitions, re-divide the data points in the partition into a plurality of sub-partitions based on the user identifications of the plurality of data points.

5. The system of claim 4, wherein to re-divide the data points in each of the plurality of partitions into the plurality of sub-partitions based on the plurality of data points, the one or more processors are further directed to cause the system to:
for each data point in the partition,
determine a Hash value of the user identification corresponding to the data point;
obtain a remainder by dividing the Hash value by an integer;
put the data points corresponding to which the remainders are equal into a same sub-partition; and
determine a sub-partition serial number for each of the plurality of sub-partitions based on the remainders corresponding to the data points in the partition.

6. The system of claim 1, wherein to obtain the estimated distribution of the plurality of data points, the one or more processors are directed to cause the system to:
select one or more data blocks from the plurality of data blocks;
for each of the selected one or more data blocks, determine a total number of data points included in the each of the selected one or more data blocks; and
determine the estimated distribution of the plurality of data points based on the total number of data points in the each of the selected one or more data blocks.

7. The system of claim 1, wherein to determine the block serial number for each of the plurality of data blocks, the one or more processors are directed to cause the system to:
determine the block serial number for each of the plurality data blocks based on a space-filling curve.

8. A method for indexing data implemented on a computing device having one or more processors and one or more storage devices, the method comprising:
obtaining a plurality of data points, each of which includes spatial information;
dividing the plurality of data points into a plurality of data blocks based on the spatial information of the plurality of data points;
determining a block serial number for each of the plurality of data blocks;
obtaining an estimated distribution of the plurality of data points;
dividing the plurality of data blocks into a plurality of partitions based on the estimated distribution of the plurality of data points and the block serial numbers of the plurality of data blocks;
determining a partition serial number for each of the plurality of partitions by ranking the plurality of partitions based on the block serial numbers of the plurality of data blocks; and
determining an index for each of the plurality of data points based on the block serial numbers of the plurality of data blocks and the partition serial numbers of the plurality of partitions.

9. The method of claim 8, further comprising:
for each of the plurality of partitions, ranking the data blocks included in the partition based on the block serial numbers of the data blocks included in the partition.

10. The method of claim 8, wherein each of the plurality of data points further includes a user identification of a user.

11. The method of claim 10, further comprising:
for each of the plurality of partitions, re-dividing the data points in the partition into a plurality of sub-partitions based on the user identifications of the plurality of data points.

12. The method of claim 11, wherein re-dividing the data points in each of the plurality of partitions into the plurality of sub-partitions based on the plurality of data points includes:
for each data point in the partition,
determining a Hash value of the user identification corresponding to the data point;
obtaining a remainder by dividing the Hash value by an integer;
putting the data points corresponding to which the remainders are equal into a same sub-partition; and
determining a sub-partition serial number for each of the plurality of sub-partitions based on the remainders corresponding to the data points in the partition.

13. The method of claim 8, wherein obtaining the estimated distribution of the plurality of data points includes:
selecting one or more data blocks from the plurality of data blocks;
for each of the selected one or more data blocks, determining a total number of data points included in the each of the selected one or more data blocks; and
determining the estimated distribution of the plurality of data points based on the total number of data points in the each of the selected one or more data blocks.

14. The method of claim 8, wherein determining the block serial number for each of the plurality of data blocks includes:
determining the block serial number for each of the plurality data blocks based on a space-filling curve.

15. A non-transitory computer readable medium, comprising at least one set of instructions for indexing data, wherein when executed by one or more processors of a computing device, the at least one set of instructions causes the computing device to perform a method, the method comprising:
obtaining a plurality of data points, each of which includes spatial information;
dividing the plurality of data points into a plurality of data blocks based on the spatial information of the plurality of data points;
determining a block serial number for each of the plurality of data blocks;
obtaining an estimated distribution of the plurality of data points;
dividing the plurality of data blocks into a plurality of partitions based on the estimated distribution of the plurality of data points and the block serial numbers of the plurality of data blocks;
determining a partition serial number for each of the plurality of partitions by ranking the plurality of partitions based on the block serial numbers of the plurality of data blocks; and
determining an index for each of the plurality of data points based on the block serial numbers of the plurality of data blocks and the partition serial numbers of the plurality of partitions.

16. The non-transitory computer readable medium of claim 15, further comprising:
for each of the plurality of partitions, ranking the data blocks included in the partition based on the block serial numbers of the data blocks included in the partition.

17. The non-transitory computer readable medium of claim 15, wherein each of the plurality of data points further includes a user identification of a user.

18. The non-transitory computer readable medium of claim 17, wherein the method further comprises:
for each of the plurality of partitions, re-dividing the data points in the partition into a plurality of sub-partitions based on the user identifications of the plurality of data points.

19. The non-transitory computer readable medium of claim 18, wherein re-dividing the data points in each of the plurality of partitions into the plurality of sub-partitions based on the plurality of data points includes:
for each data point in the partition,
determining a Hash value of the user identification corresponding to the data point;
obtaining a remainder by dividing the Hash value by an integer;
putting the data points corresponding to which the remainders are equal into a same sub-partition; and
determining a sub-partition serial number for each of the plurality of sub-partitions based on the remainders corresponding to the data points in the partition.

20. The non-transitory computer readable medium of claim 15, wherein obtaining the estimated distribution of the plurality of data points includes:
selecting one or more data blocks from the plurality of data blocks;
for each of the selected one or more data blocks, determining a total number of data points included in the each of the selected one or more data blocks; and
determining the estimated distribution of the plurality of data points based on the total number of data points in the each of the selected one or more data blocks.

21. (canceled)
